(19) United States
(12) Patent Application Publication
(10) Pub. No.: US 2009/0057038 A1
(43) Pub. Date: Mar. 5, 2009

(54) LOAD CELL-TYPE ELECTRONIC BALANCE

(76) Inventor: Tetsuro Kusumoto, Kyoto (JP)

Correspondence Address: J C PATENTS, INC., 4 VENTURE, SUITE 250, IRVINE, CA, 92618, US

(21) Appl. No.: 11/914,202

(22) PCT Filed: Jun. 6, 2006
(86) PCT No.: PCT/JP2006/311311

§ 371 Date: Nov. 12, 2007

(30) Foreign Application Priority Data
Jun. 7, 2005 (JP) 2005-166895

(51) Int. Cl. G01G 3/14

(52) U.S. Cl. 177/211

(57) ABSTRACT

A load cell-type electronic balance is provided, in which a change in load detection sensitivity caused by creep effects is reduced. A load having a predetermined magnitude is loaded to a load cell (1a), used for load detection, for a certain period until creep characteristics of the load cell (1a) are stabilized. The load is sampled and measured by a calculation/control section (3) constructed from a microcomputer, and a correction formula for correcting a temporal change of the load caused by creep effects is calculated and stored. From the next time when the power is turned on, measurement data are corrected using the correction formula.

### CROSS-REFERENCE TO RELATED APPLICATION

This application claims the priority benefit of PCT application serial no. PCT/JP2006/311311, filed on Jun. 6, 2006, and which claims Japanese patent application no. 2005-166895, filed Apr. 25, 2005. The entirety of each of the above-mentioned patent applications is incorporated herein by reference and made a part of this specification.

### BACKGROUND OF THE INVENTION

1. Field of the Invention

The present invention relates to a load cell-type electronic balance, and more particularly to a load cell-type electronic balance formed by attaching a plurality of strain gauges on an elastomer.

2. Description of Related Art

In the current load cell-type electronic balance, the following measures are taken to deal with the creep phenomenon: preparing a plurality of strain gauges with slightly different patterns, and particularly, preparing a plurality of strain gauges with different tab ratios; measuring the creep, and meanwhile, changing any one of four strain gauges or changing all the strain gauges into different patterns, so as to seek for an optimal combination of the strain gauges.

In the strain gauge-type load cell, a plurality of strain gauges is generally attached on an elastomer that is elastically deformed due the effects of a load, so as to form a Wheatstone bridge by the strain gauges, and an output of the Wheatstone bridge serves as a detecting output for the magnitude of the load applied to the elastomer.

FIG. 7 is a three-dimensional view of a current load cell. An elastomer of the load cell has a pair of pillars 11, 12, which are connected by two upper and lower girders having flexible parts on both ends respectively. Furthermore, one strain gauge is attached at four flexible parts respectively, and totally four strain gauges S1-S4 are attached, and thus forming a Wheatstone bridge caused by a reference voltage E shown in FIG. 8.

In the above configuration, any one of the pillars 11 and 12 is fixed, for example, the pillar 11 is fixed. When the load is applied to the other pillar 12, the resistance of each of the strain gauges S1-S4 is changed due to the elastic deformation of each flexible part; thus, a voltage signal in proportion to the load is generated from the output end V of the Wheatstone bridge.

The load cell is used as, for example, a load unit for an electronic balance. When it is required to detect the load correctly, the creep phenomenon that the measurement values shown in FIG. 9 change with time are a problem. In order to deal with the creep phenomenon, the following measures are taken for the current load cells: preparing a plurality of strain gauges with slightly different patterns, and particularly, preparing a plurality of strain gauges with different tab ratios based on the patterns of the strain gauges; measuring the creep, and meanwhile, changing any one of the strain gauges S1-S4 or changing all the strain gauges to be different patterns, so as to seek for an optimal combination of the strain gauges.

The current load cell has the following problems. In order to adjust the creep, not only the preparation of a plurality of strain gauges is required, it is also time consuming and labor intensive for determining the optimal combination of strain gauges.

Moreover, it is substantially difficult to adjust the creep phenomenon after the strain gauges are adhered. Therefore, when the strain gauges are used as load sensors for an electronic balance, the high resolution of the electronic balance becomes a problem. Furthermore, the following problem also exists, i.e., a cell for correcting the non-uniformity between the creeps of the same electronic balance does not exist. For example, in Japanese Patent Publication No. 2003-322571, a load cell is disclosed for solving the problems. As shown in FIG. 10, in the configuration of the load cell, a plurality of Wheatstone bridges is formed by attaching strain gauges S1-S4 and S5-S8 on one elastomer, and the load detection value is indicated by the linear sum of outputs of the plurality of Wheatstone bridges. When calculating the linear sum, the coefficients to be multiplied by the output of each Wheatstone bridge are set as values for counteracting the creeps indicated in each Wheatstone bridge.

Patent document 1: Japanese Patent Publication No. 2003-322571

The current load cell-type electronic balance is formed through the manners described above, in which the creep characteristics will be greatly changed due to the environment in which the electronic balance is being used, particularly, due to temperature and humidity. Therefore, if the load cell-type electronic balance is formed through the following two methods, it is difficult to eliminate the creep error in all the environments in which the electronic balance is being used, and one method includes: preparing a plurality of strain gauges with slightly different tab ratios, and measuring the creep, and meanwhile, changing one of the strain gauges S1-S4 or changing all the strain gauges into different patterns, so as to seek for an optimal combination of the strain gauges; and the other method includes forming a plurality of Wheatstone bridges by attaching a plurality of strain gauges S1-S8 on an elastomer. The subject of the present invention is to reduce the creep error in accord with the using environment of the electronic balance. The present invention is developed in view of the above content and aims at providing a load cell-type electronic balance that is capable of reducing the creep error regardless of the using environment of the electronic balance.

### SUMMARY OF THE INVENTION

Accordingly, the present invention is directed to a load cell-type electronic balance. In the load cell-type electronic balance of the present invention, a load cell formed by attaching a plurality of strain gauges on an elastomer serves as a load detection section, and includes: a creep storage unit, for measuring a creep corresponding to a magnitude and a load time of a load on a tray in a using environment and storing the creep measurement data; and a creep correction calculation/storage unit, for calculating a creep correction in the using environment according to the creep measurement data and storing the creep correction data, and then adding the measured load with the creep correction so as to correct a creep error.

Furthermore, the load cell-type electronic balance of the present invention includes a built-in weight, a weight changing device for increasing or reducing the built-in weight, and a control section for controlling the weight changing device, to apply the built-in weight in a predetermined time, so as to correct a creep error. The load cell-type electronic balance of the present invention is formed in said manner above and can reduce the creep error in the using environments.

### [Effects of the Invention]

The load cell-type electronic balance of the present invention stores the creep characteristics in a certain environment in which the electronic balance is used, and performs a correction calculation process; thus, the creep characteristics corresponding to the temperature and humidity in the using environment can be properly corrected.

In order to make the aforementioned and other objects, features, and advantages of the present invention comprehensible, preferred embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of an electronic balance structure according to the present invention.

FIG. 2 is a flow chart of a sequence for obtaining a creep correction formula.

FIG. 3 shows a creep characteristic curve and a creep correction curve.

FIG. 4 is a flow chart of a sequence for displaying measurement values of the electronic balance according to the present invention.

FIG. 5 is a block diagram of an electronic balance structure according to another embodiment of the present invention.

FIG. 6 is a flow chart of a sequence for displaying measurement values of the electronic balance according to another embodiment of the present invention.

FIG. 7 is a three-dimensional view of a load cell structure.

FIG. 8 is a structural view of a Wheatstone bridge.

FIG. 9 shows the variation of the measurement values for the electronic balance caused by the creep characteristics of a load cell.

FIG. 10 is a three-dimensional view of another structures in the load cell.

### DESCRIPTION OF EMBODIMENTS

The load cell-type electronic balance of the present invention has the following characteristics. The first characteristic of the load cell-type electronic balance lies in that a load cell formed by attaching a plurality of strain gauges on an elastomer serves as a load detection section, and the load cell-type electronic balance includes: a creep storage unit, for measuring a creep corresponding to a magnitude and a load time of a load on a tray in a using environment and storing the creep measurement data; and a creep correction calculation/storage unit, for calculating a creep correction in the using environment according to the creep measurement data, and storing the creep correction data, and adding the measured load with the creep correction so as to correct a creep error. The second characteristic of the load cell-type electronic balance lies in that a built-in weight, a weight changing device for increasing or reducing the built-in weight, and a control section for controlling the weight changing device are included to apply the built-in weight in a predetermined time, so as to correct the creep error. Therefore, the basic structure of the most preferred implementation aspect has both the first and second characteristics.

### Embodiment 1

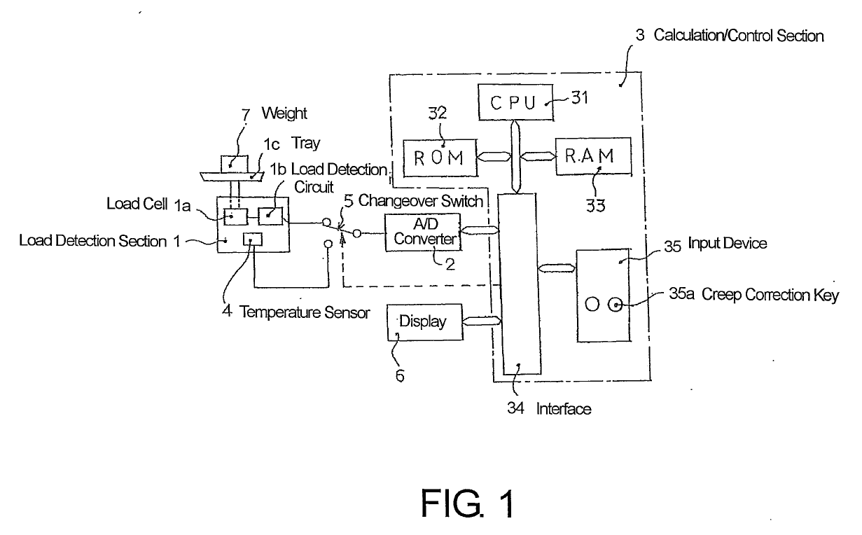

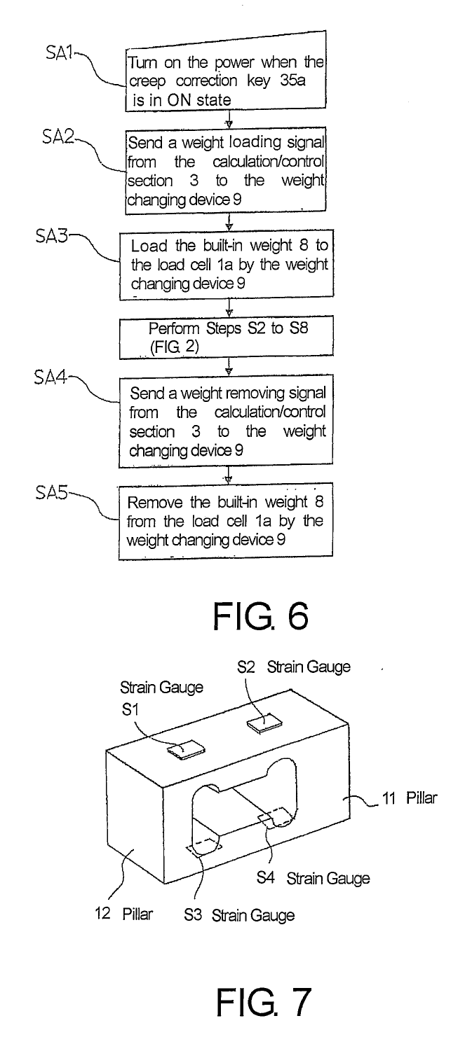

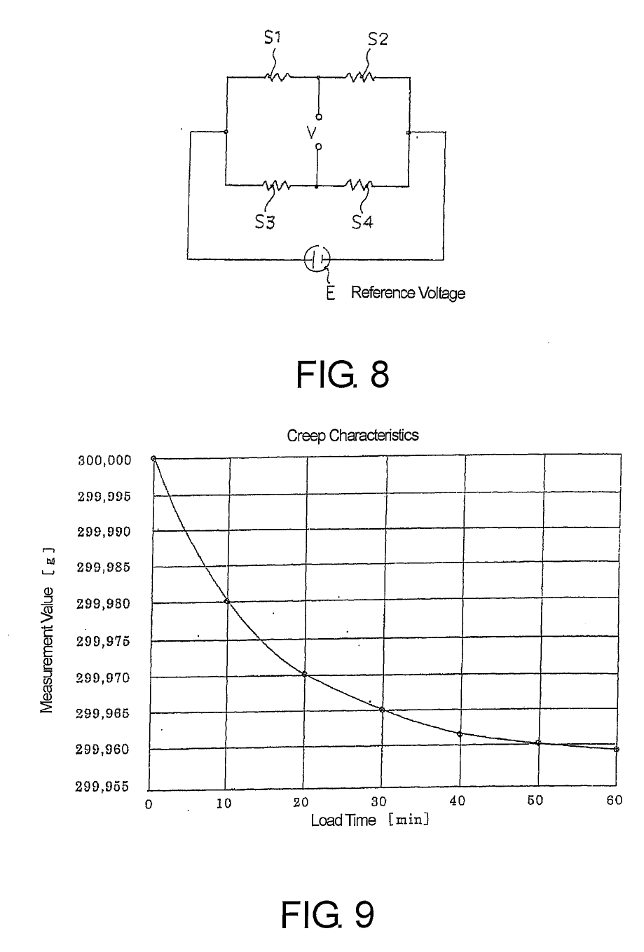

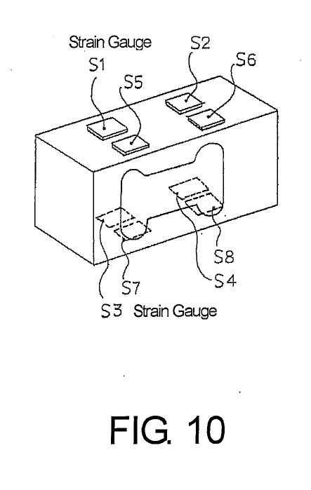

Hereinafter, the load cell-type electronic balance of the present invention is illustrated in detail below with reference to the following embodiments. FIG. 1 is a block diagram of an electronic balance structure according to the present invention. The electronic balance includes: a load detection section 1, having a load cell 1a and a load detection circuit 1b, in which the load cell 1a has strain gauges attached on the elastomer, similar to the load cell in FIG. 7, and the load detection circuit 1b forms a Wheatstone bridge by using the strain gauges; a changeover switch 5 and an A/D converter 2, for alternately switching an output signal of the load detection circuit 1b and an output signal of a temperature sensor 4 which is used for detecting the temperature T within the load detection section 1 and performing an A/D conversion; a calculation/control section 3, for controlling the changeover switch 5 and the A/D converter 2, and reading a digital signal from the A/D converter 2, and converting the digital signal into a weight value; and a display 6, for displaying the weight value.

The calculation/control section 3 is formed by taking a microcomputer as a main body, which includes a central processing unit (CPU) 31, a read only memory (ROM) 32, a random access memory (RAM) 33, an interface 34, and an input device 35 with a creep correction key 35a, wherein the creep correction key 35a is used for inputting to correct the creep error. A general measurement and display program is written into the ROM 32, and additionally, a temperature correcting program and a creep correcting program are also written therein. The temperature correcting program is used to obtain a correction value that is used to eliminate the load detection error caused by the difference between the reference temperature and the detection temperature T; and the creep correcting program is used to obtain the following creep characteristics and to correct the creep. Furthermore, the RAM 33 has a region or working region for storing the digital conversion data from the load detection circuit 1b, and further has a region for storing the creep correction formula obtained by the creep correcting program.

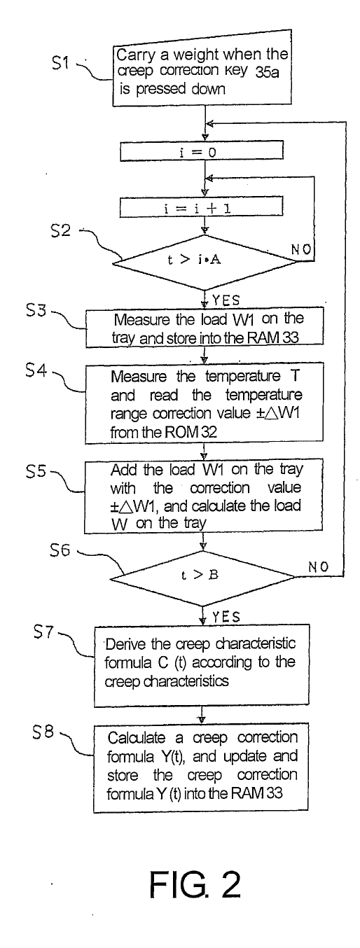

FIG. 2 is a flow chart of a sequence for obtaining a creep correction formula. The creep correction formula is used to correct the changing of the load detection sensitivity of the load cell caused by the creep phenomenon of the strain gauges. Hereinafter, referring to FIGS. 1 and 2, the sequence for obtaining the creep correction formula is illustrated. Once the creep correction key 35a of the input device 35 is pressed down, if a weight 7 for correcting the creep is carried on a tray 1c in FIG. 1, the program for obtaining the creep correction formula is automatically enabled (S1). When the calculation/control section 3 confirms that the time interval t, continued since the program has commenced, has reached the time A corresponding to the sample period A (S2), the changeover switch 5 is switched to the side of the load detection circuit 1b, and an A/D conversion is performed on a load W1 on the tray, the calculation/control section 3 converts the load W1 on the tray into a digital signal and reads the digital signal into the calculation/control section 3 through the interface 34, and then store the load WI on the tray into the RAM 33 (S3). Thereafter, the changeover switch 5 is switched to the side of the temperature sensor 4, and similarly, the temperature T is read into the calculation/control section 3, and a correction value ±ΔW1 corresponding to the load WI on the tray at the temperature T is read from the ROM 32 (S4).

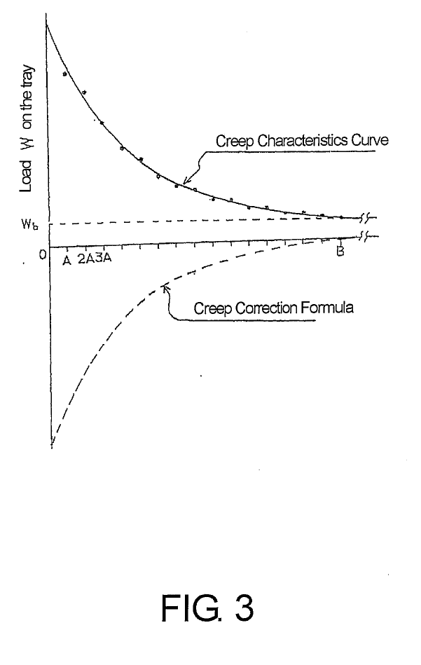

Next, the load W1 on the tray and the corrected value ±ΔW1 are added and converted into a load W on the tray (S5). A series of processing is performed during each sample period A till the time duration t lasted from the very beginning reaches a total time B. The total time B is predetermined to be a time at which the load W on the tray becomes stable. As a result, the creep characteristics shown as black dots in FIG. 3 can be obtained (S6). A creep characteristics curve C (t) is derived using a statistic method in which the sum of the square of the dispersion of the creep characteristics is minimized (S7). Thereafter, a creep correction formula Y (t) is calculated by the following formula, in which the correction formula Y (t) is updated and stored in the RAM 33 (S8).

Y(t)=Wb−C(t) (1).

Furthermore, Wb indicates a load on the tray at time B.

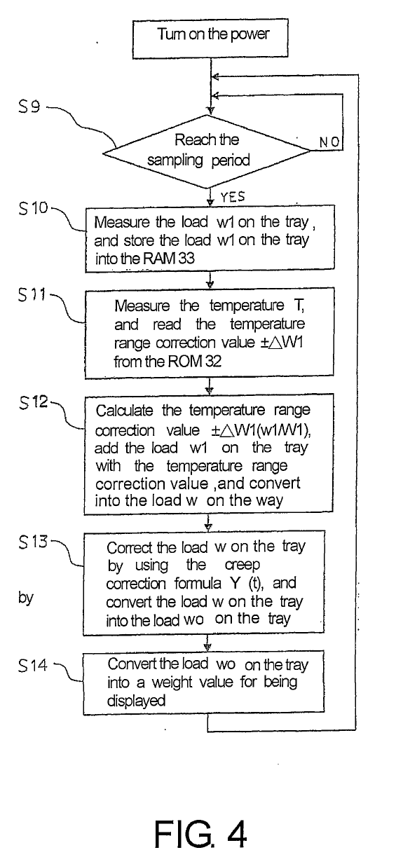

FIG. 4 is a flow chart of a sequence for displaying measurement values of the electronic balance according to the present invention. After turning on the power of the electronic balance, whether the sample period (S9) is reached or not is being monitored. If the sample period is reached, a control signal is sent from the calculation/control section 3 for switching the changeover switch 5 to the side of the load detection circuit 1b. Then, an A/D converter 2 is used to convert the load w1 on the tray of the subject to be measured into a digital value, and the digital value is stored into the RAM 33 (S10). Next, the changeover switch 5 is switched to the side of the temperature sensor 4. Similarly, the temperature T is converted into a digital value, and the digital value is read into the calculation/control section 3, and then a temperature range correction value ±ΔW1 is read from the ROM 32 at the temperature T (S11). Thereafter, a temperature range correction value ±ΔW1 (w1/W1) corresponding to the load w1 on the tray is calculated. The temperature range correction value ±ΔW1 (w1/W1) and the load w1 on the tray are added and converted into a load w on the tray shown by the formula (2) (S12).

w=w1±ΔW1(w1/W1) (2).

Next, after reading the creep correction formula Y(t) from the RAM 33, the creep correction value Y(t) (w1/W1) is calculated, and then the creep correction value Y(t) (w1/W1) and the load on the tray w are added and converted into a load on the tray wo shown by the formula (3) (S13). Then, the load w0 on the tray is multiplied by a weight conversion coefficient, and the weight measurement value is displayed on the display 6 (S14).

wo=w+Y(t)(w1/W1) (3).

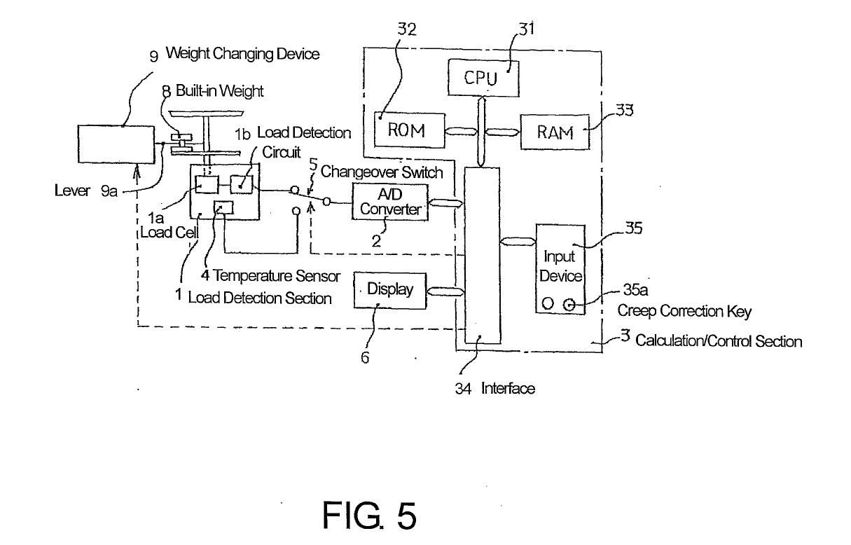

FIG. 5 shows a structure of an electronic balance according to another embodiment of the present invention. As shown in FIG. 5, besides those structures that are same as those of the electronic balance in FIG. 1, the electronic balance further includes a built-in weight 8 and a weight changing device 9. The weight changing device 9 moves a lever 9a upwards an d downwards according to the control signal from the calculation/control section 3, so as to load the built-in weight 8 on the load cell 1a or remove the built-in weight 8 from the load cell 1a.

FIG. 6 is a flow chart of a sequence for obtaining a creep correction formula of the electronic balance according to the present invention. If the power is turned on under the condition that the creep correction key 35a is pressed down (SA1), the calculation/control section 3 sends out a weight carrying signal to the weight changing device 9 (SA2), and the weight changing device 9 load the built-in weight 8 to the load cell 1a (SA3). Next, the steps of S2 to S8 in FIG. 2 are performed in the same sequence, and the correction formula Y(t) is updated and stored in the RAM 33. Then, a weight removing signal is sent from the calculation/control section 3 to the weight changing device 9 (SA4), and the weight changing device 9 removes the built-in weight 8 from the load cell 1a, and the process is finished (SA5).

The load cell-type electronic balance of the present invention obtains the creep characteristics in proportion to the magnitude and the load time of the load, converts the creep characteristics into a time function and derives a creep correction formula, and then corrects the creep characteristics by using the correction formula. The load cell-type electronic balance of the present invention is not limited to those described in the embodiments. For example, a plurality of lines can be used to approximate the time function. Additionally, the correction weight can also be used as the built-in weight 8.

### INDUSTRIAL APPLICABILITY

The present invention is applicable for a high-precision electronic balance, in which the creep characteristics influenced by temperature and humidity cannot be ignored.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A load cell-type electronic balance, wherein a load cell formed by attaching a plurality of strain gauges on an elastomer serves as a load detection section, the load cell-type electronic balance is characterized in comprising: a creep storage unit, for measuring a creep corresponding to a magnitude and a load time of a load on a tray in a using environment and storing a creep measurement data; and a creep correction calculation/storage unit, for calculating a creep correction in the using environment according to the creep measurement data and storing the creep correction data, and adding the measured load with the creep correction so as to correct a creep error.

2. The load cell-type electronic balance as claimed in claim 1, further comprising a built-in weight, a weight changing device for increasing or reducing the built-in weight, and a control section for controlling the weight changing device to load the built-in weight in a predetermined time, so as to correct a creep error.
